(19) United States
(12) Patent Application Publication
(10) Pub. No.: US 2025/0170550 A1
(43) Pub. Date: May 29, 2025

(54) PULSED COLUMN FOR LIQUID-LIQUID EXTRACTION WITH PACKING

(71) Applicants: COMMISSARIAT A L'ENERGIE ATOMIQUE ET AUX ENERGIES ALTERNATIVES, Paris (FR); ORANO Recyclage, CHATILLON (FR); ELECTRICITÉ DE FRANCE, Paris (FR)

(72) Inventors: Hervé ROUSSEL, LAUDUN (FR); Frank DUTILH, LAUDUN (FR)

(21) Appl. No.: 18/899,134

(22) Filed: Sep. 27, 2024

(30) Foreign Application Priority Data
Sep. 29, 2023 (FR) 2310446

(51) Int. Cl. B01J 19/32; B01D 11/04

(52) U.S. Cl. CPC B01J 19/32; B01D 11/04; B01J 2219/32231; B01J 2219/32255

(57) ABSTRACT

A pulsed column for liquid-liquid extraction, including a cylindrical tube of longitudinal axis (Z) and inside diameter (D₀) and packing located inside the tube. The packing includes a rod extending along the longitudinal axis (Z) and a plurality of truncated discs secured and regularly distributed along the rod with a separation (E) and each extending in a transverse plane (P) perpendicular to said rod, each of the truncated discs having, as their perimeter in the transverse plane (P), two arcs of a circle of radius (R) connected by two identical parallel rectilinear edges spaced apart by a distance (D), any two of the adjacent truncated discs being oriented with respect to each other in the transverse plane (P) by a non-zero orientation angle (θ).

The present invention lies in the field of chemical engineering and more particularly liquid-liquid extraction. Among the various devices for performing a liquid-liquid extraction operation continuously, the pulsed column is known, which comprises a cylindrical tube and a set of immobile solid pieces constituting an obstacle to the movement of the liquids, called packing and housed inside this tube. In operation, this tube is placed vertically and two non-miscible liquids circulate in this tube in opposite directions (the heavier liquid being introduced at the top and the lighter liquid being introduced at the bottom). Under the effect of the pulsing (oscillating movement applied to all the liquids) and of the packing, one of the liquids is dispersed in the other in the form of drops. This dispersion increases the contact surface between the two liquids, which enables one or more solutes initially contained in one of these liquids to be transferred to the other liquid.

Thus the invention relates to a pulsed column for liquid-liquid extraction comprising a cylindrical tube with longitudinal axis Z and inside diameter D₀ and packing located inside the tube.

Several solutions are known with regard to the packing housed in the tube. In a first solution illustrated in FIG. 4A, the packing 120 consists of a rod 130 and a series of regularly spaced elements 140 mounted on this rod 130, which passes through these elements 140. This rod 130 extends along the longitudinal axis Z, which is the longitudinal axis of the tube 110. The tube 110 is shown schematically in broken lines. Each element 140 is a truncated circular disc 143, i.e. the disc has a single rectilinear edge the length of which is less than the diameter of the disc, the remainder of the circumference of the disc being a portion of a circle. Each truncated disc 143 extends in a transverse plane (perpendicular to the longitudinal axis Z). The truncated discs 143 are disposed along the rod 130 so that any two adjacent truncated discs 143 are oriented at 180° to each other (i.e. two adjacent discs 143, if they were disposed in the same transverse plane, would be symmetrical with each other with respect to the longitudinal axis X). The distance between two adjacent truncated discs 143 is constant. This packing is referred to as “truncated-disc packing”.

However, packing with truncated discs has insufficient efficacy in the case of small-diameter tubes, for example diameters of the order of 15 mm, and/or in the case where one of the liquids has a viscosity very much greater than the viscosity of the other liquid. Insufficient efficacy means a transfer of material between the two liquids that is too small compared with a perfect theoretical mixer, and a column height that is too great to obtain a given transfer of material. One cause of this low efficacy is often excessive axial mixing (along the longitudinal axis Z). This mixing is characterised by a coefficient of axial dispersion Dₐₓ. The higher this coefficient, the lower the efficacy of transfer of material implemented in the column. Thus, for a column with a diameter of 15 cm and one of the liquids with a viscosity of 8 cP (centipoise), a total specific flow rate (TSFR) of 2 L/h/cm² (i.e. a total flow rate of the two phases of 3.5 L/h), a pulse amplitude of 1.5 cm and a pulse frequency of 1 Hz (this test is referred to as standard test), a coefficient of axial dispersion Dₐₓ of 6.9 cm²/s for truncated discs spaced apart by 2 cm is obtained.

To attempt to improve the efficacy of the column, a first solution is envisaged that consists in reducing the distance between the elements 140. The tests implemented showed that this configuration afforded a reduction in the coefficient of axial dispersion Dₐₓ of the column. For the above standard test, a Dₐₓ of 2.1 cm²/s is obtained for truncated discs spaced apart by 1 cm, which is lower than the Dₐₓ value of 6.9 cm²/s for truncated discs spaced apart by 2 cm.

A second solution has also been envisaged, illustrated in FIG. 4B, in which the packing 120 consists of two parallel rods 130 and a series of regularly spaced elements 140 mounted on these two rods, which pass through these elements 140. These rods 130 extend along the longitudinal axis Z, which is the longitudinal axis of the tube 110. The tube 110 is shown schematically in broken lines. A first type of element 140 is a ring 141 (a circular disc pierced at its centre with a hole to form an annulus) and a second type of element 140 is a circular disc 142 the diameter of which is greater than the diameter of the hole in the ring 141 and less than the outside diameter of the ring 141. Each ring 141 and each disc 142 extends in a transverse plane P (perpendicular to the longitudinal axis Z). The rings 141 and the discs 142 are disposed in alternation along the two rods 130 so that each disc 142 is located between two rings 141, and the distance between a ring 142 and an adjacent disc 141 is constant. This packing is referred to as “disc and ring packing”. For the above standard test, and with a distance between a ring 142 and an adjacent disc 141 equal to 1 cm, a Dₐₓ of 3.5 cm²/s is obtained, which is lower than the Dₐₓ value of 6.9 cm²/s for truncated discs spaced apart by 2 cm.

However, the tests implemented with the first solution and with the second solution above showed that the ranges of values of the operating parameters (pulse amplitude and frequency in the column, flow rate through the column) for which a satisfactory hydrodynamic functioning exists were small compared with the configuration where the elements 140 were more spaced apart. In particular, the maximum total specific flow rate (TSFR) before congestion of the column (i.e. when it is impossible for the two liquids to circulate in opposite directions) DSTₘₐₓ is smaller for the first solution (DSTₘₐₓ=2 L/h/cm²) and for the second solution (DSTₘₐₓ=1.8 L/h/cm²) than for truncated discs more spaced apart (DSTₘₐₓ=3 L/h/cm²).

### DESCRIPTION OF THE INVENTION

The present invention aims to remedy these drawbacks.

The invention aims to propose a pulsed column for liquid-liquid extraction that has a mixing efficacy as high as possible, and satisfactory hydrodynamic functioning over a range of operating-parameter values that is as wide as possible.

This aim is achieved by virtue of the fact that the packing comprises a rod extending along the longitudinal axis Z and a plurality of truncated discs secured and regularly distributed along the rod and each extending in a transverse plane P perpendicular to the rod with a separation E, each of the truncated discs having, as their perimeter in the transverse plane P, two arcs of a circle of radius R connected by two identical parallel rectilinear edges spaced apart by a distance D, any two adjacent discs being oriented with respect to each other in a transverse plane P by a non-zero orientation angle.

By virtue of these provisions, the mixing of the two liquids in the pulsed column is implemented more effectively. The hydrodynamic functioning is satisfactory over a range of operating-parameter values that is wider than in the case of the packings of the prior art.

For example, the separation E between two adjacent discs is constant.

For example, the separation E is of the same order of magnitude as the diameter D₀ of the tube.

For example, the separation E is less than the diameter D₀ of the tube.

For example, the diameter D₀ of the tube is less than 50 mm.

For example, the separation E between two adjacent discs is equal to 10 mm and the diameter D₀ of the tube is equal to 15 mm.

For example, the ratio of the transverse surface of the disc to the surface of the internal cross section of the tube is between 75% and 80%.

For example, at least the surface of the discs is produced from a hydrophilic material.

For example, at least the surface of the discs is produced from a hydrophobic material.

For example, the rectilinear edges are crenelated.

For example, the orientation angle is equal to 90°.

The invention will be clearly understood and the advantages thereof will appear best from the reading of the following detailed description of embodiments depicted by way of non-limitative examples. The description refers to the accompanying drawings, on which:

### BRIEF DESCRIPTION OF THE DRAWINGS

FIG. 1A and FIG. 1B—FIG. 1A is a side view of a pulsed column for liquid-liquid extraction according to the invention; FIG. 1B is a cross section along the line B-B of FIG. 1A that shows a truncated disc according to the invention.

FIG. 2—FIG. 2 is a perspective view of a portion of the pulsed column of FIG. 1A.

FIG. 3—FIG. 3 is a perspective view of another embodiment of a truncated disc of the pulsed column according to the invention.

FIG. 4A and FIG. 4B—FIG. 4A is a perspective view of a portion of a pulsed column according to the prior art; FIG. 4B is a perspective view of a portion of another pulsed column according to the prior art.

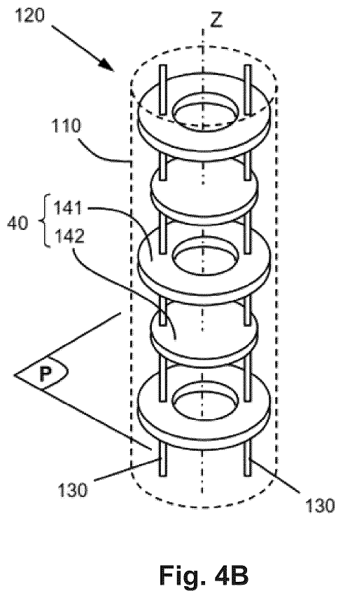

### DETAILED DESCRIPTION OF THE INVENTION

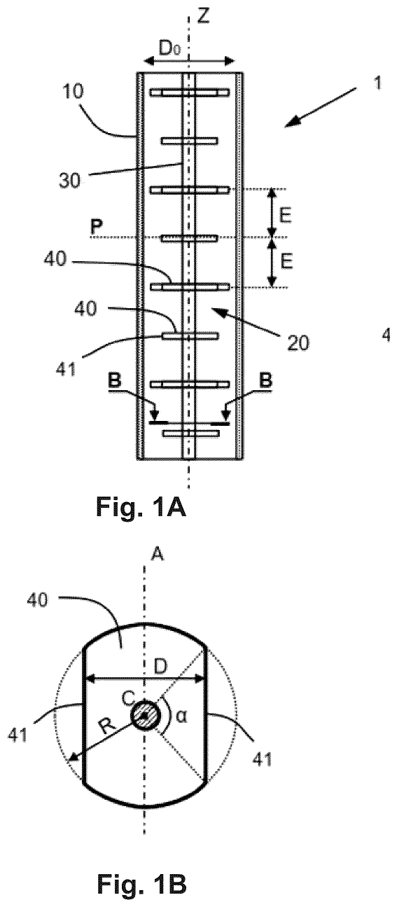

FIG. 1A illustrates a pulsed column 1 that enables liquid-liquid extraction continuously by the vertical positioning of this pulsed column 1 and the circulation of two non-miscible liquids in opposite directions in this pulsed column 1 (the heavier liquid being introduced at the top and the lighter liquid being introduced at the bottom) and then the application of a pulsing (oscillating movement) to these two liquids. For example, one of these liquids is aqueous (for example water) and the other liquid is organic.

The pulsed column 1 comprises a cylindrical tube 10 of longitudinal axis Z and inside diameter D₀ and packing 20 located inside this tube 10. The packing 20 comprises a rod 30 that extends along the longitudinal axis Z and a plurality of truncated discs 40 regularly distributed along the rod 30. For example, the rod 30 is located at the centre of the tube 10 and therefore has the longitudinal axis Z passing through it. For example, the rod 30 is cylindrical. The discs 40 are provided with a hole through which the rod 30 passes and are secured to the rod 30 by any means, for example by welding. Two adjacent discs 40 are spaced apart by a distance E (referred to as the separation) measured along the longitudinal axis Z. For example, this separation E is constant, i.e. is identical for any two adjacent discs 40. Each of the discs 40 extends in a transverse plane P, i.e. perpendicular to the longitudinal axis Z and thus to the rod 30.

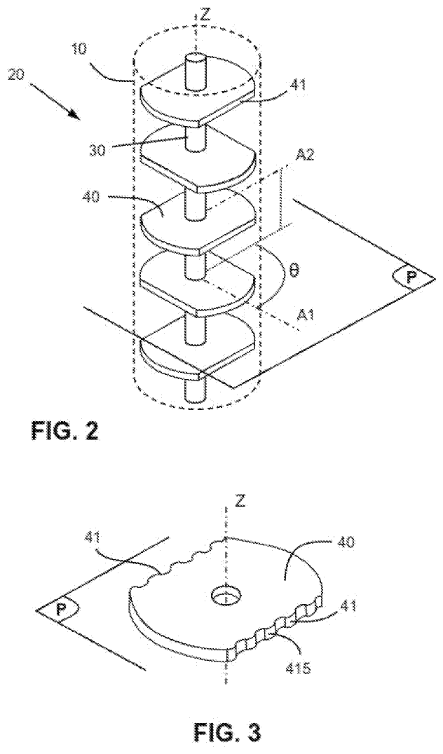

FIG. 1B is a cross section along the line B-B in FIG. 1A, which shows a disc 40, i.e. in its transverse plane P. Each of the discs 40 has as its perimeter in the transverse plane P two arcs of a circle of radius R and of centre C that are separate and identical and are connected by two identical parallel rectilinear edges 41 spaced apart by a distance D. The disc 40 is therefore truncated at two points, and is symmetrical with respect to its centre C through which the longitudinal axis Z passes. The orientation axis A of a disc 40 in the plane P is defined as the transverse axis that passes through the centre C and is parallel to the rectilinear edges 41. Any two adjacent discs 40 (called first and second discs) are oriented with respect to each other in the transverse plane P by a non-zero orientation angle θ. As illustrated in FIG. 2, the orientation angle θ is the angle between the orientation axis A1 of the first disc 40 and the orientation axis A2 of the second disc 40.

For example, the orientation angle θ is equal to 90°, as illustrated in FIG. 2, i.e. any two adjacent discs 40 are at a right angle with respect to each other.

For example, the separation E between two adjacent discs 40 is of the same order of magnitude as the diameter D₀ of the tube 10. For example, this separation E is less than the diameter D₀ of the tube 10. For example, the diameter D₀ of the tube 10 is less than 50 mm, example less than 15 mm. For example, the separation E is equal to 10 mm.

The inventors carried out tests under the same operating conditions of the pulsed column as described above (standard test) in the case of the use of the packings of the prior art. Thus, for a column with inside diameter D₀=15 cm, a separation E=1 cm and one of the liquids with a viscosity of 8 cP (centipoise), a total specific flow rate (TSFR) of 2 L/h/cm² (i.e. a total flow rate of the two phases of 3.5 L/h), a pulsing amplitude of 1.5 cm and a pulsing frequency of 1 Hz, the inventors obtained a Dₐₓ of 3.6 cm²/s. With regard to the range of use, the maximum total specific flow rate (TSFR) before congestion of the column DSTₘₐₓ obtained was equal to 3 L/h/cm². These values of Dₐₓ and of DSTₘₐₓ are better than those obtained with use of the packings of the prior art.

Transparency of the packing 20 means the ratio of the surface left free for the liquid to pass at a disc 40, called S_{L}, to the surface of the cross section (in a plane perpendicular to the internal longitudinal axis Z) of the tube 10, called S_{T}, and which is therefore S_{T}=π·(½D₀)². The surface S_{L} left free for the liquid to pass is S_{L}=S1+S2, where S1 is the surface of a ring of external radius ½D₀ and of internal radius R, i.e. S1=(S−πR²), and S2 is the removed surface of a disc 40. The removed surface S2 of a disc 40 is equal to the surface of a circle of radius R minus the surface S_{D} of the disc 40 (i.e. the surface of this disc 40 in a plane perpendicular to the longitudinal axis Z). The surface S_{D} of the disc 14 is therefore SD={[α−sin(α)]·R²} with cos(α/2)=D/2R) where α is the angle of the truncated angular sectors, illustrated on FIG. 1B, and D is the distance defined above and illustrated in FIG. 1B. The removed surface S2 of a disc 40 is therefore equal to S2=πR²−S_{D}. The transparency is thus equal to S_{L}/S_{T}.

For example, this transparency is between 20% and 25%. For example, the diameter D₀ of the tube 10 is equal to 15 mm, the radius R of the disc 40 is equal to 7.25 mm and the distance D is equal to 10.55 mm, which gives a transparency of 22%. A transparency of between 20% and 25% corresponds to a ratio S_{D}/S_{T} of the transverse surface S_{D} of the disc 40 to the surface of the internal cross section S_{T} of the tube 10 of between 75% and 80%. This is because S_{T}=S_{D}+S1+S2=S_{D}+S_{L} and therefore S_{D}/S_{T}=1−{transparency}.

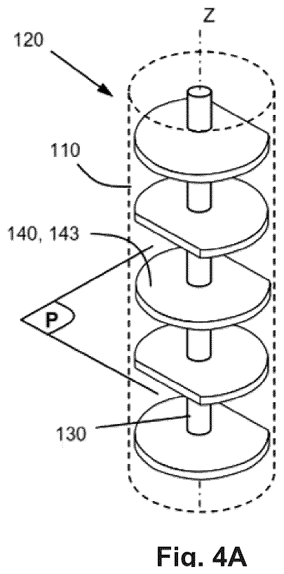

According to an embodiment illustrated in FIG. 3, the rectilinear edges 41 of each disc 40 are crenelated, i.e. each rectilinear edge 41 has a crenelation 415. The reliefs of this crenelation 415 are visible to the naked eye and are distinct from roughness, roughness not being visible to the naked eye. This crenelation 415 favours the formation of smaller drops and contributes to increasing the efficacy of the mixing of the two liquids that are circulating in the tube 10.

The discs 40 can be produced from any material. Advantageously, this material is hydrophilic (for example a stainless steel), or at least the surface of the discs 40 is produced from a hydrophilic material, which minimises the adhesion of the organic liquid to the discs 40 (operation said to be in “continuous aqueous phase”). Alternatively, this material is hydrophobic (for example a polymer such as PTFE), or at least the surface of the discs 40 is produced from a hydrophobic material (for example the disc 40 is produced from a stainless steel covered with such a polymer), which minimises the adhesion of the water to the discs 40 (operation said to be in “continuous organic phase”).

1. A pulsed column for liquid-liquid extraction, comprising a cylindrical tube of longitudinal axis (Z) and inside diameter (D₀) and packing located inside said tube, said packing being characterised in that it comprises a rod extending along said longitudinal axis (Z) and a plurality of truncated discs secured and regularly distributed along said rod with a separation (E) and each extending in a transverse plane (P) perpendicular to said rod, each of said truncated discs having, as their perimeter in said transverse plane (P), two arcs of a circle of radius (R) connected by two identical parallel rectilinear edges spaced apart by a distance (D), any two of said adjacent truncated discs being oriented with respect to each other in said transverse plane (P) by a non-zero orientation angle (θ).

2. The pulsed column according to claim 1, such that said separation (E) between two adjacent discs is constant.

3. The pulsed column according to claim 2, such that said separation (E) is of the same order of magnitude as said diameter (D₀) of the tube.

4. The pulsed column according to claim 2, such that said separation (E) is less than said diameter (D₀) of the tube.

5. The pulsed column according to claim 1, such that said diameter (D₀) of the tube (10) is less than 50 mm.

6. The pulsed column according to claim 5, such that said separation (E) is equal to 10 mm and said diameter (D₀) of the tube is equal to 15 mm.

7. The pulsed column according to claim 1, such that the ratio of the transverse surface (S_{D}) of said disc to the surface of the internal cross section (S_{T}) of said tube is between 75% and 80%.

8. The pulsed column according to claim 1, such that at least the surface of said discs is produced from a hydrophilic material.

9. The pulsed column according to claim 1, such that at least the surface of said discs is produced from a hydrophobic material.

10. The pulsed column according to claim 1, such that said the rectilinear edges are crenelated.

11. The pulsed column according to claim 1, wherein said the orientation angle (θ) and is equal to 90°.
